(19) United States
(12) Patent Application Publication
(10) Pub. No.: US 2006/0164368 A1
(43) Pub. Date: Jul. 27, 2006

(54) Display apparatus with reduced power consumption in charging/discharging of data line

(75) Inventor: Youichi Tobita, Tokyo (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Mitsubishi Denki Kabushiki Kaisha, Tokyo (JP)

(21) Appl. No.: 11/265,210

(22) Filed: Nov. 3, 2005

(30) Foreign Application Priority Data
Jan. 27, 2005 (JP) 2005-019469

(51) Int. Cl. G09G 3/36

(52) U.S. Cl. 345/98

(57) ABSTRACT

A comparator compares an input voltage input in the current write cycle with a voltage (output voltage) of a data line set in the immediately preceding write cycle. Based on the result of comparison made by the comparator, one of two switches is turned on to cause either a charging circuit including a first constant current source or a discharging circuit including a second constant current source to be connected to a node. This allows the voltage written in the data line in the immediately preceding write cycle to be effectively used in the current write cycle. Thus, power consumption in charging/discharging of the data line is reduced.

### BACKGROUND OF THE INVENTION

1. Field of the Invention

The present invention relates to a display apparatus, and more particularly to the configuration of a driving circuit for driving pixels having voltage-driven display devices.

2. Description of the Background Art

A conventional driving circuit for driving a liquid crystal display is disclosed in, e.g., Japanese Patent Application Laid-Open No. 2004-166039. The driving circuit illustrated in FIG. 2 of this document is a capacitive-element driving circuit for driving a capacitive element (load capacity of data line) CL on the basis of an input voltage V_{IN}, and includes a first constant current source Q2 for supplying current from a first power source VDD to the capacitive element CL, a second constant current source Q1 for leading current from the capacitive element CL to a second power source VSS, a first comparator 10 for comparing the input voltage V_{IN} with an output voltage V_{OUT} applied to the capacitive element CL and a second comparator 11 for comparing the input voltage V_{IN} with a predetermined reference voltage Vthl2. Based on the result of comparison made by the second comparator 11, the capacitive element CL is charged through the first power source VDD or discharged through the second power source VSS. Thereafter, based on the result of comparison made by the first comparator 10, the capacitive element CL is charged through the first constant current source Q2 or discharged through the second constant current source Q1. Accordingly, when the voltage of the capacitive element CL reaches the input voltage V_{IN}, the capacitive element CL remains at that voltage.

The conventional driving circuit disclosed in the above-mentioned document, however, causes the following problems.

First, the capacitive element CL is previously charged through the first power source VDD or discharged through the second power source VSS based on the result of comparison made by the second comparator 11, so that the charging/discharging of data line increases power consumption.

Second, the first and second comparators 10 and 11 consume great power.

Lastly, time delays resulting from comparisons made by the first and second comparators 10 and 11 cause a voltage difference (offset voltage) between the input voltage V_{IN} and output voltage V_{OUT}.

### SUMMARY OF THE INVENTION

An object of the present invention is to obtain a display apparatus capable of reducing power consumption in charging/discharging of data line and power consumed by a comparator as well as dropping an offset voltage resulting from time delays in the comparator.

According to a first aspect of the present invention, the display apparatus includes a pixel having a voltage-driven display device, a signal line serving as a data line connected to the pixel, and a driving circuit for receiving gradation voltages corresponding to display data, each being received as an input voltage, and writing an output voltage based on the input voltage into the signal line. The driving circuit includes a first charging circuit and a first discharging circuit, each being selectively connected to the signal line and a comparator for comparing the input voltage input in a current write cycle with a voltage of the signal line set in a preceding write cycle. One of the first charging circuit and the first discharging circuit is connected to the signal line based on a result of comparison made by the comparator, to thereby set the voltage of the signal line at the input voltage.

Power consumption resulting from charging/discharging of the signal line can be reduced.

According to a second aspect of the invention, the display apparatus includes a pixel having a voltage-driven display device, a signal line serving as a data line connected to the pixel, and a driving circuit for receiving gradation voltages corresponding to display data, each being received as an input voltage, and writing an output voltage based on the input voltage into the signal line. The driving circuit includes a first charging circuit and a first discharging circuit, each being selectively connected to the signal line, a precharge circuit for setting a voltage of the signal line at an intermediate voltage between a voltage corresponding to a highlight value and a voltage corresponding to a shadow value and a comparator for comparing the input voltage with the voltage of the signal line set at the intermediate voltage. One of the first charging circuit and the first discharging circuit is connected to the signal line based on a result of comparison made by the comparator, to thereby set the voltage of the signal line at the input voltage.

Power consumption resulting from charging/discharging of the signal line can be reduced.

According to a third aspect of the invention, the display apparatus includes a pixel having a voltage-driven display device, a data line connected to the pixel, a gradation voltage generating circuit for generating gradation voltages, driving circuits, each receiving one of the gradation voltages as an input voltage and outputting an output voltage based on the input voltage, a signal line for connecting the data line and the driving circuit, and a decoder circuit for selecting the output voltage corresponding to display data and writing the selected output voltage into the data line. The driving circuit includes a first charging circuit and a first discharging circuit, each being selectively connected to the signal line, and a comparator for comparing the input voltage input in a current write cycle with a voltage of the signal line set in a preceding write cycle. One of the first charging circuit and the first discharging circuit is connected to the signal line based on a result of comparison made by the comparator, to thereby set the voltage of the signal line at the input voltage.

Power consumption resulting from charging/discharging of the signal line can be reduced.

According to a fourth aspect of the invention, the display apparatus includes a pixel having a voltage-driven display device, a data line connected to the pixel, a gradation voltage generating circuit for generating gradation voltages, driving circuits, each receiving one of the gradation voltages as an input voltage and outputting an output voltage based on the input voltage, a signal line for connecting the data line and the driving circuit, and a decoder circuit for selecting the output voltage corresponding to display data and writing the selected output voltage into the data line. The driving circuit includes a first charging circuit and a first discharging circuit, each being selectively connected to the signal line, a precharge circuit for setting a voltage of the signal line at an intermediate voltage between a voltage corresponding to a highlight value and a voltage corresponding to a shadow value, and a comparator for comparing the input voltage with the voltage of the signal line set at the intermediate voltage. One of the first charging circuit and the first discharging circuit is connected to the signal line based on a result of comparison made by the comparator, to thereby set the voltage of the signal line at the input voltage.

Power consumption resulting from charging/discharging of the signal line can be reduced.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating the overall configuration of a liquid crystal display according to a first preferred embodiment of the present invention;

FIG. 2 is a circuit diagram illustrating the configuration of a liquid crystal driving circuit according to the first preferred embodiment;

FIGS. 3 and 4 are timing charts each illustrating an operation of the liquid crystal driving circuit according to the first preferred embodiment;

FIG. 5 is a circuit diagram illustrating the configuration of a liquid crystal driving circuit according to a second preferred embodiment of the invention;

FIG. 6 is a circuit diagram illustrating the configuration of a liquid crystal driving circuit according to a third preferred embodiment of the invention;

FIG. 7 is a circuit diagram illustrating the configuration of a liquid crystal driving circuit according to a fourth preferred embodiment of the invention;

FIG. 8 is a circuit diagram illustrating the configuration of part of a liquid crystal driving circuit according to a variant of the fourth preferred embodiment;

FIG. 9 is a timing chart illustrating an operation of the liquid crystal driving circuit according to the fourth preferred embodiment;

FIG. 10 is a circuit diagram illustrating the configuration of a liquid crystal driving circuit according to a fifth preferred embodiment of the invention;

FIG. 11 is a circuit diagram illustrating the configuration of a liquid crystal driving circuit according to a sixth preferred embodiment of the invention;

FIG. 12 is a circuit diagram illustrating the configuration of a liquid crystal driving circuit according to a seventh preferred embodiment of the invention;

FIG. 13 is a timing chart illustrating an operation of the liquid crystal driving circuit according to the seventh preferred embodiment;

FIG. 14 is a circuit diagram illustrating the configuration of a liquid crystal driving circuit according to an eighth preferred embodiment of the invention;

FIG. 15 is a circuit diagram illustrating the configuration of a liquid crystal driving circuit according to a ninth preferred embodiment of the invention;

FIG. 16 is a circuit diagram illustrating the configuration of a liquid crystal driving circuit according to a tenth preferred embodiment of the invention;

FIG. 17 is a block diagram illustrating the overall configuration of a liquid crystal display according to an eleventh preferred embodiment of the invention; and

FIG. 18 is a circuit diagram illustrating the configuration of part of a decoder circuit according to the eleventh preferred embodiment.

### DESCRIPTION OF THE PREFERRED EMBODIMENTS

Preferred embodiments of the present invention will now be described in detail with reference to the accompanied drawings. Same or similar elements will be indicated by the same reference characters in the drawings.

### First Preferred Embodiment

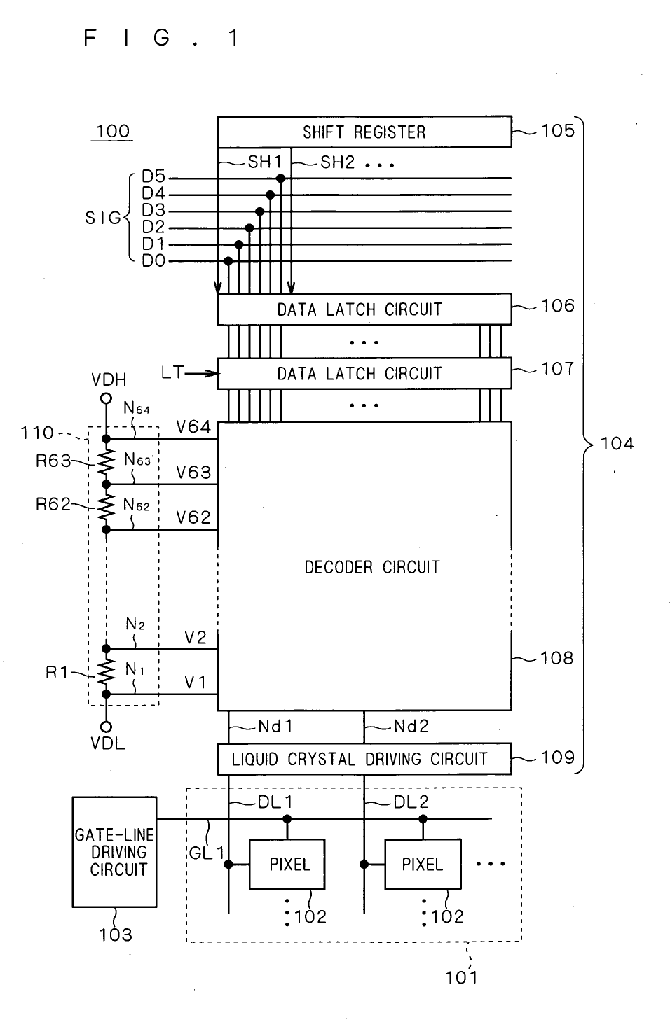

FIG. 1 is a block diagram illustrating the overall configuration of a liquid crystal display 100 according to a first preferred embodiment of the present invention. The liquid crystal display 100 includes a liquid crystal array part 101, a gate-line driving circuit 103 and a source driver 104.

The liquid crystal array part 101 has a plurality of pixels 102 arrayed in a matrix. A gate line GL is provided for each row of the liquid crystal array part 101, and a data line DL is provided for each column. FIG. 1 representatively illustrates pixels 102 in the first row in the first and second columns as well as their corresponding gate line GL1 and data lines DL1, DL2.

The source driver 104 outputs display voltages set stepwise based on display data SIG which is N-bit digital data, to the data line DL. In FIG. 1, as an example, the display data SIG is assumed to contain 6-bit data, i.e., display data bits D0 to D5.

Based on such 6-bit display data SIG, 26=64 grayscale tones can be displayed in each pixel 102. Further, approximately 260 thousand colors of display can be achieved by forming one color display unit by three pixels 102 of R (Red), G (Green) and B (Blue).

The source driver 104 includes a shift register 105, data latch circuits 106, 107, a gradation voltage generating circuit 110, a decoder circuit 108 and a liquid crystal driving circuit 109.

The display data SIG is serially generated in correspondence with the display luminance of respective pixels 102. In other words, the display data bits D0 to D5 indicate at each timing the display luminance of one pixel 102 in the liquid crystal array part 101.

The shift register 105 generates data-line address signals SH1, SH2, . . . , each of which gives an instruction to the data latch circuit 106 to capture the display data bits D0 to D5 in synchronization with a predetermined cycle during which the settings of the display data SIG are changed. The data latch circuit 106 sequentially captures and latches serially-generated display data SIG for one pixel line.

A series of display data SIG latched by the data latch circuit 106 is transferred to the data latch circuit 107 in response to activation of a latch signal LT with timing when display data SIG for one pixel line is captured in the data latch circuit 106.

The gradation voltage generating circuit 110 is formed by 63 resistor dividers connected in series between a high potential VDH and a low potential VDL, for applying 64 levels of gradation voltages V1 to V64 to gradation voltage nodes N₁ to N₆₄, respectively.

The decoder circuit 108 decodes display data SIG latched by the data latch circuit 107, and based on the decoded display data SIG, selects a voltage from among the gradation voltages V1 to V64 and outputs the selected voltage to a decoder output node Nd. In the present embodiment, the decoder circuit 108 outputs display voltages for one pixel line in parallel on the basis of the display data SIG latched by the data latch circuit 107. FIG. 1 representatively illustrates decoder output nodes Nd1 and Nd2 corresponding to the data line DL1 in the first column and the data line DL2 in the second column, respectively.

The liquid crystal driving circuit 109 outputs analog voltages respectively corresponding to the respective display voltages output to the decoder output nodes Nd1, Nd2, . . . , to the data lines DL1, DL2, . . . , respectively.

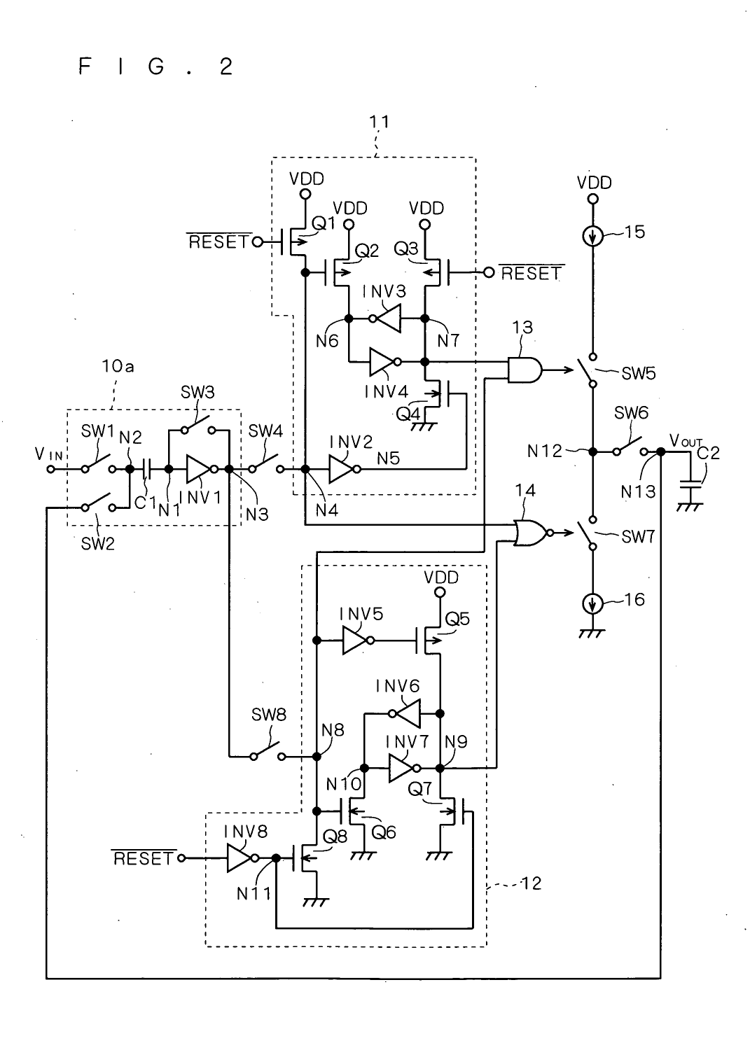

FIG. 2 is a circuit diagram illustrating the configuration of the liquid crystal driving circuit 109 according to the first preferred embodiment. As illustrated in FIG. 2, the liquid crystal driving circuit 109 includes a comparator (switched comparator) 10a, latch circuits 11, 12, an AND circuit 13, a NOR circuit 14, constant current sources 15, 16 formed by transistors and the like, and switching devices (hereinafter referred to as “switches”) SW4 to SW8.

The comparator 10a has a capacitive element C1, an inverter INV1 and switches SW1 to SW3. The switch SW1 is connected between a terminal for receiving an input voltage V_{IN} and a node N2. The switch SW2 is connected between the node N2 and an output node N13. The capacitive element C1 is connected between the node N2 and a node N1. The inverter INV1 has an input terminal connected to the node N1 and an output terminal connected to a node N3. The switch SW3 is connected between the nodes N1 and N3.

The switch SW4 is connected between the node N3 and a node N4.

The latch circuit 11 has PMOS transistors Q1 to Q3, an NMOS transistor Q4 and inverters INV2 to INV4. The PMOS transistor Q1 has a gate connected to a terminal for receiving a reset signal \overline{RESET}, a source connected to a source potential VDD and a drain connected to the node N4. The PMOS transistor Q2 has a gate connected to the node N4, a source connected to the source potential VDD and a drain connected to a node N6. The PMOS transistor Q3 has a gate connected to a terminal for receiving a reset signal \overline{RESET}, a source connected to a source potential VDD and a drain connected to a node N7. The NMOS transistor Q4 has a gate connected to the output terminal of the inverter INV2, a source connected to a ground potential and a drain connected to the node N7. The inverter INV2 has an input terminal connected to the node N4 and an output terminal connected to the gate of the NMOS transistor Q4. The inverter INV3 has an input terminal connected to the node N7 and an output terminal connected to the node N6. The inverter INV4 has an input terminal connected to the node N6 and an output terminal connected to the node N7. The inverters INV3 and INV4 constitute a flip-flop circuit.

The switch SW8 is connected between the nodes N3 and N8.

The latch circuit 12 has a PMOS transistor Q5, NMOS transistors Q6 to Q8 and inverters INV5 to INV8. The PMOS transistor Q5 has a gate connected to the output terminal of the inverter INV5, a source connected to the source potential VDD and a drain connected to a node N9. The NMOS transistor Q6 has a gate connected to a node N8, a source connected to the ground potential and a drain connected to a node N10. The NMOS transistor Q7 has a gate connected to a node N11, a source connected to the ground potential and a drain connected to the node N9. The NMOS transistor Q8 has a gate connected to the node N11, a source connected to the ground potential and a drain connected to the node N8. The inverter INV5 has an input terminal connected to the node N8 and an output terminal connected to the gate of the PMOS transistor Q5. The inverter INV6 has an input terminal connected to the node N9 and an output terminal connected to the node N10. The inverter INV7 has an input terminal connected to the node N10 and an output terminal connected to the node N9. The inverter INV8 has an input terminal connected to a terminal for receiving a reset signal \overline{RESET} and an output terminal connected to the node N11. The inverters INV6 and INV7 constitute a flip-flop circuit.

The AND circuit 13 has a first input terminal connected to the node N7, a second input terminal connected to the node N8 and an output terminal connected to the switch SW5. An “H” (high) signal output from the AND circuit 13 turns on the switch SW5, and an “L” (low) signal output from the AND circuit 13 turns off the switch SW5.

The NOR circuit 14 has a first input terminal connected to the node N4, a second input terminal connected to the node N9 and an output terminal connected to the switch SW7. An “H” signal output from the NOR circuit 14 turns on the switch SW7, and an “L” signal output from the NOR circuit 14 turns off the switch SW7.

The constant current source 15 is connected between the source potential VDD and switch SW5. The switch SW5 is connected between the constant current source 15 and a node N12. The switch SW7 is connected between the node N12 and constant current source 16. The constant current source 16 is connected between the switch SW7 and ground potential. The switch SW6 is connected between the node N12 and output node N13. A capacitive element C2 is parasitic capacitance of data line DL illustrated in FIG. 1, and is illustrated equivalently as a capacitive element between the output node N13 and ground potential.

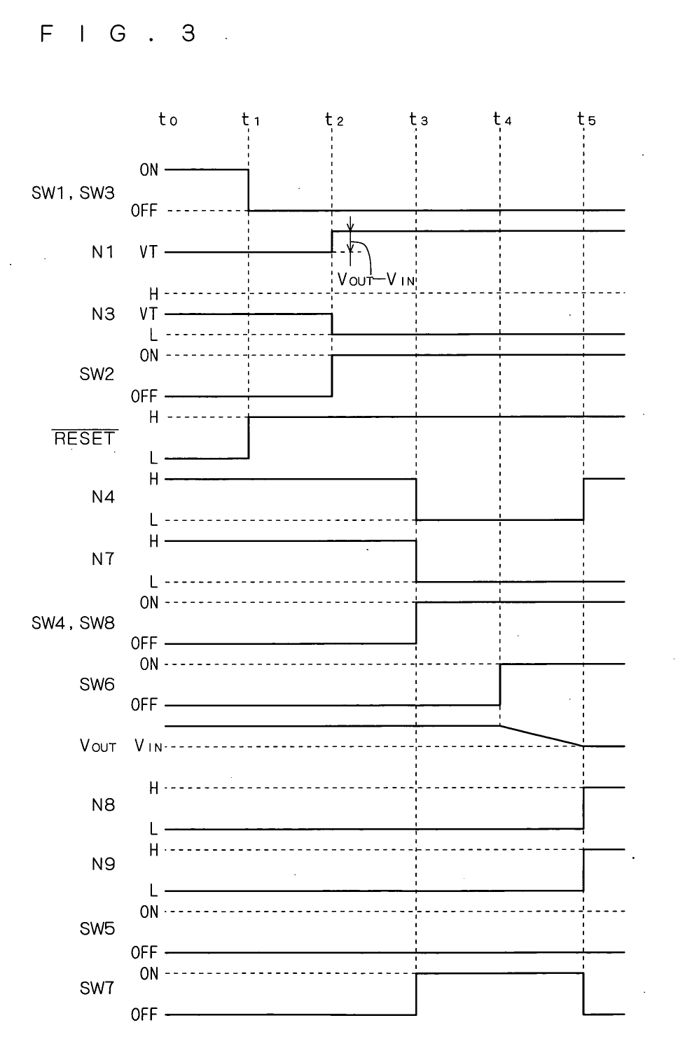

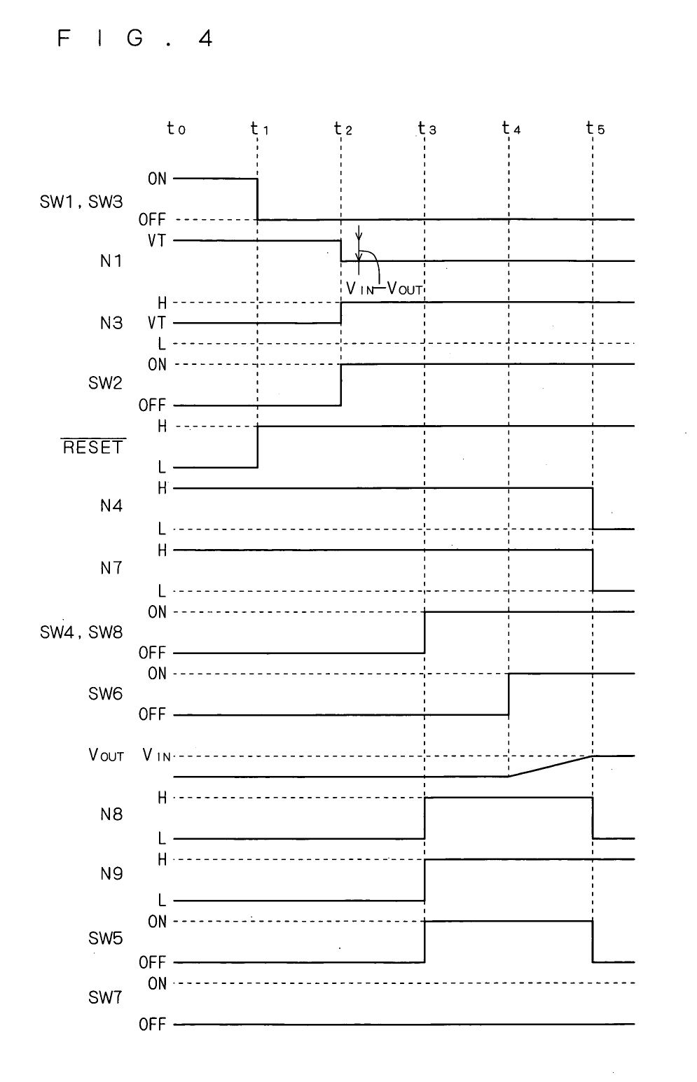

FIGS. 3 and 4 are timing charts each illustrating an operation of the liquid crystal driving circuit 109 illustrated in FIG. 2. Referring to FIGS. 2 and 3, at time t0, the latch circuits 11 and 12 are reset by applying an “L” reset signal \overline{RESET}. As a result, the potential at each of the nodes N4 and N7 transitions to HIGH, while the potential at each of the nodes N8 and N9 transitions to LOW. Accordingly, the output from each of the AND circuit 13 and NOR circuit 14 becomes LOW, turning off the switches SW5 and SW7. Further, at time t0, the switches SW1 and SW3 are turned on. As a result, the node N2 is charged up to the input voltage V_{IN}, and the potential at each of the nodes N1 and N3 transitions to a threshold voltage VT of the inverter INV1.

Next, at time t1, the switches SW1 and SW3 are turned off, while the reset signal \overline{RESET} transitions to HIGH. If the potential at each of the nodes N4, N7, N8, N9, N1 and N3 is set as described above, applying the reset signal RESET and switching the switches SW1 and SW3 are not necessarily performed with the same timing.

Next, at time t2, the switch SW2 is turned on. The potential at the node N2 then transitions from the input voltage V_{IN} input in the current write cycle to the output voltage V_{OUT} set in an immediately preceding write cycle. When V_{OUT}>V_{IN} holds (FIG. 3 illustrates waveforms in this case), the capacitive coupling of the capacitive element C1 causes the potential at the node N1 to rise by V_{OUT} minus V_{IN}. As a result, the input voltage to the inverter INV1 becomes higher than the threshold voltage VT, causing the potential at the node N3 to transition to LOW.

Next, at time t3, the switches SW4 and SW8 are turned on. Then, the potential at the node N4 transitions to LOW, while the potential at the node N5 transitions to HIGH. As a result, the output from the latch circuit 11 is reversed, and the potential at the node N7 transitions to LOW. On the other hand, the output from the latch circuit 12 is not reversed when the potential at the node N8 transitions to LOW, and the potential at the node N9 is kept LOW.

Accordingly, the output from the AND circuit 13 remains LOW, so that the switch SW5 is held off. That is, the constant current source 15 and node N12 remain cut off, so that no charge path is formed. On the other hand, since the potential at the node N4 transitions to LOW, the output from the NOR circuit 14 becomes HIGH, and the switch SW7 is turned on. That is, the constant current source 16 and node N12 are connected, so that a discharge path is formed.

Next, at time t4, the switch SW6 is turned on. Then, the output node N13 is discharged through the constant current source 16, causing the potential at the output node N13 (output voltage V_{OUT}) to gradually drop.

At time t5, when the output voltage V_{OUT} drops to the input voltage V_{IN} (that is, when the output voltage V_{OUT} in the current write cycle becomes equal to the input voltage V_{IN}), the output from the inverter INV1 is reversed to cause the potential at the node N4 to transition to HIGH. Then, the output from the latch circuit 12 is reversed while the output from the latch circuit 11 is not reversed, causing the potential at each of the nodes N8 and N9 to transition to HIGH. The output from the latch circuit 11 is reversed only when the input potential (potential at the node N4) transitions from HIGH to LOW, and the output from the latch circuit 12 is reversed only when the input potential (potential at the node N8) transitions from LOW to HIGH.

As a result, the output from the NOR circuit 14 becomes LOW, turning off the switch SW7, so that the discharging at the output node N13 is stopped. At this time, the output from the AND circuit 13 remains LOW by the output from the latch circuit 11, and therefore, the switch SW5 is held off. Accordingly, the charge path and discharge path are both cut off, so that the condition in which the output voltage V_{OUT} is set equal to the input voltage V_{IN} is maintained.

The above description has been directed to the operation when the input voltage V_{IN} input in the current write cycle is lower than the output voltage V_{OUT} set in the immediately preceding write cycle (that is, when V_{IN}<V_{OUT} holds), however, a similar operation can be performed in the opposite case (that is, when V_{IN}>V_{OUT} holds) as will be described hereinbelow.

Referring to FIGS. 2 and 4, the operations at time t0 and time t1 are the same as those described above.

Next, at time t2, the switch SW2 is turned on. Then, the potential at the node N2 transitions from the input voltage V_{IN} input in the current write cycle to the output voltage V_{OUT} set in the immediately preceding write cycle. When V_{OUT}<V_{IN} holds, the capacitive coupling caused by the capacitive element C1 causes the potential at the node N1 to drop by V_{IN} minus V_{OUT}. As a result, the input voltage to the inverter INV1 becomes lower than the threshold voltage VT, causing the potential at the node N3 to transition to HIGH.

Next, at time t3, the switches SW4 and SW8 are turned on. Then, the potential at the node N8 transitions to HIGH. As a result, the output from the latch circuit 12 is reversed, and the potential at the node N9 transitions to HIGH. On the other hand, the potential at each of the nodes N4 and N5 does not vary, so that the output from the latch circuit 11 is not reversed, and the potential at the node N7 is kept HIGH.

Accordingly, the output from the NOR circuit 14 remains LOW, so that the switch SW7 is held off. That is, the constant current source 16 and node N12 remain cut off, so that no discharge path is formed. On the other hand, the output from the AND circuit 13 becomes HIGH, turning on the switch SW5. That is, the constant current source 15 and node N12 are connected, so that a charge path is formed.

Next, at time t4, the switch SW6 is turned on. Then, the output node N13 is charged through the constant current source 15, causing the potential at the output node N13 (output voltage V_{OUT}) to gradually rise.

At time t5, when the output voltage V_{OUT} rises to reach the input voltage V_{IN} (that is, when the output voltage V_{OUT} in the current write cycle becomes equal to the input voltage V_{IN}), the output from the inverter INV1 is reversed to cause the potential at the node N4 to transition to LOW. Then, the output from the latch circuit 11 is reversed while the output from the latch circuit 12 is not reversed, causing the potential at the node N7 to transition to LOW.

As a result, the output from the AND circuit 13 becomes LOW, turning off the switch SW5, so that the charging at the output node N13 is stopped. At this time, the potential at the node N8 transitions to LOW, however, the output from the latch circuit 12 is not reversed, and the potential at the node N9 is kept HIGH. Therefore, the output from the NOR circuit 14 remains LOW, causing the switch SW7 to be held off. Accordingly, the charge path and discharge path are both cut off, so that the condition in which the output voltage V_{OUT} is set equal to the input voltage V_{IN} is maintained.

The above description has been directed to the case of using the constant current sources 15 and 16 formed by transistors and the like as means for charging/discharging the data line DL (capacitive element C2). However, the present invention is not limited as such, but any other element or circuit that can charge/discharge the output node N13 may be used instead. For instance, the constant current sources 15 and 16 may be replaced by a resistive element or charge pump circuit. The use of resistive element achieves simpler circuit configuration than in the case of using the constant current sources 15 and 16. Alternatively, the use of charge pump circuit can reduce variations in current values as compared to the case of using the constant current sources 15 and 16 because a capacitive element having less variations determines current values for charging/discharging.

According to the liquid crystal display 100 of the present embodiment, the comparator 10a included in the liquid crystal driving circuit 109 compares the input voltage V_{IN} input in the current write cycle with the voltage of the data line DL (output voltage V_{OUT}) set in the immediately preceding write cycle. Then, based on the result of comparison made by the comparator 10a, either the switch SW5 or SW7 is turned on, so that either a charging circuit including the constant current source 15 or a discharging circuit including the constant current source 16 is connected to the node N12. Accordingly, the voltage written in the data line DL in the immediately preceding write cycle can effectively be utilized in the current write cycle, which can reduce power consumption resulting from charging/discharging of the data line DL as compared to the liquid crystal display disclosed in the above-mentioned JP2004-166039 in which the output voltage V_{OUT} is once set HIGH or LOW in the current write cycle.

The liquid crystal driving circuit 109 controls the turning on/off of the switches SW5 and SW7 by the latch circuits 11, 12, AND circuit 13 and NOR circuit 14, based on the result of comparison made by the comparator 10a. This achieves easier control of the turning on/off of the switches as well as faster switching operations than in the case of controlling the turning on/off of switches in response to a control signal input from outside (for instance, the above-mentioned JP2004-166039 describes controlling the turning on/off of switches by an external switch controller).

### Second Preferred Embodiment

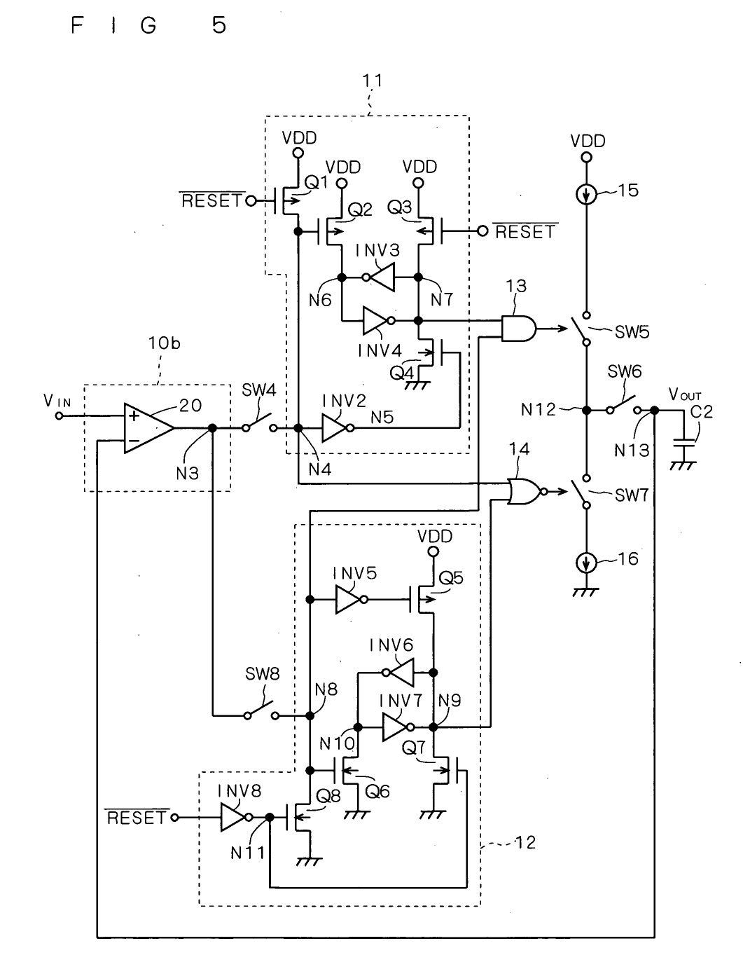

FIG. 5 is a circuit diagram illustrating the configuration of the liquid crystal driving circuit 109 according to a second preferred embodiment of the invention. As illustrated in FIG. 5, the liquid crystal driving circuit 109 includes a comparator 10b as well as the latch circuits 11, 12, AND circuit 13, NOR circuit 14, constant current sources 15, 16 and switches SW4 to SW8 as described in the first preferred embodiment.

The comparator 10b has a differential amplifier 20. The differential amplifier 20 has a first input terminal (+ side) connected to a terminal for receiving the input voltage V_{IN}, a second input terminal (− side) connected to the output node N13 and an output terminal connected to the node N3.

The comparator 10b according to the present embodiment has similar functions as the comparator 10a according to the first preferred embodiment.

According to the liquid crystal display 100 of the present embodiment, the use of the differential amplifier 20 in the comparator 10b can reduce the number of switches as compared to the first preferred embodiment using the switched comparator 10a. Therefore, the control circuit for controlling switches can be made simpler in configuration.

### Third Preferred Embodiment

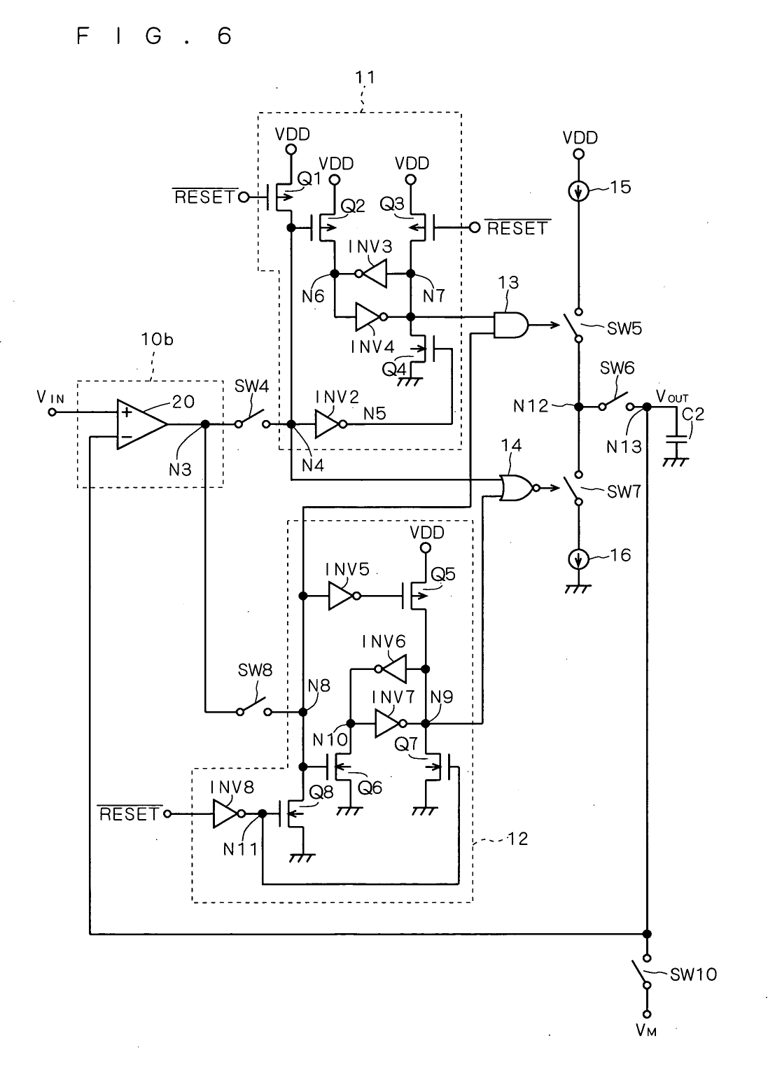

FIG. 6 is a circuit diagram illustrating the configuration of the liquid crystal driving circuit 109 according to a third preferred embodiment of the invention. As illustrated in FIG. 6, the liquid crystal driving circuit 109 includes a switch SW10 as well as the comparator 10b, latch circuits 11, 12, AND circuit 13, NOR circuit 14, constant current sources 15, 16 and switches SW4 to SW8 as described in the second preferred embodiment. The switch SW10 is connected between the output node N13 and an intermediate potential V_{M}. The intermediate potential V_{M} is located halfway between an output voltage V_{OUT} given by display data SIG of the highlight value (hereinafter referred to as an “output voltage V_{OUTH}”) and an output voltage V_{OUT} given by display data SIG of the shadow value (hereinafter referred to as an “output voltage V_{OUTL}”). Turning on the switch SW10, the voltage of the data line DL is set at an intermediate voltage between the output voltage V_{OUTH} and output voltage V_{OUTL}. That is, the switch SW10 serves as a precharge circuit for setting the voltage of the data line DL at an intermediate voltage between a voltage corresponding to the highlight value and the voltage corresponding to the shadow value.

An operation of the liquid crystal driving circuit 109 according to the third preferred embodiment will now be described. First, resetting the latch circuits 11 and 12 by applying an “L” reset signal \overline{RESET}, the switches SW5 and SW7 are turned off.

Next, the switch SW10 is turned on, so that the voltage of the data line DL (potential at the output node N13) is precharged up to the intermediate potential V_{M}. The comparator 10b compares the input voltage V_{IN} with the intermediate potential V_{M}. When V_{M}>V_{IN} holds, an “L” signal is output, and when V_{M}<V_{IN} holds, an “H” signal is output.

Next, the switches SW4 and SW8 are turned on. When an “L” signal is output from the comparator 10b (that is, when V_{M}>V_{IN} holds), the switch SW5 is turned off, and the switch SW7 is turned on, so that a discharge path is formed. When an “H” signal is output from the comparator 10b (that is, when V_{M}<V_{IN} holds), the switch SW5 is turned on, and the switch SW7 is turned off, so that a charge path is formed.

Next, after the switch SW1 is turned off, the switch SW6 is turned on. Then, the potential at the output node N13 gradually drops when a discharge path is formed, and gradually rises when a charge path is formed.

When the output voltage V_{OUT} becomes equal to the input voltage V_{IN}, the output from the comparator 10b is reversed. As a result, the switch SW5 or SW7 held on is turned off.

The above description has been directed to the case of applying the invention according to the third preferred embodiment on the basis of the second preferred embodiment, however, the invention according to the third preferred embodiment may be applied to the first preferred embodiment.

According to the liquid crystal display 100 according to the third preferred embodiment, the voltage of the data line DL is precharged up to the intermediate potential V_{M}, and the comparator 10b compares the input voltage V_{IN} with the intermediate potential V_{M}. Based on the result of comparison made by the comparator 10b, either the switch SW5 or SW7 is turned on, causing either the charging circuit or discharging circuit to be connected to the node N12. This can reduce power consumption resulting from charging/discharging of the data line DL as compared to the liquid crystal display disclosed in the above-mentioned JP JP2004-166039 in which the output voltage V_{OUT} is once set HIGH or LOW in the current write cycle.

Further, the voltage of the data line DL is precharged up to the intermediate potential V_{M} between the voltage corresponding to the highlight value and the voltage corresponding to the shadow value. Thus, considering all the input gradation voltages, the amplitude of writing voltages can be minimized in total. As a result, the write time in the data line DL is totally shorter than in the first and second preferred embodiments.

### Fourth Preferred Embodiment

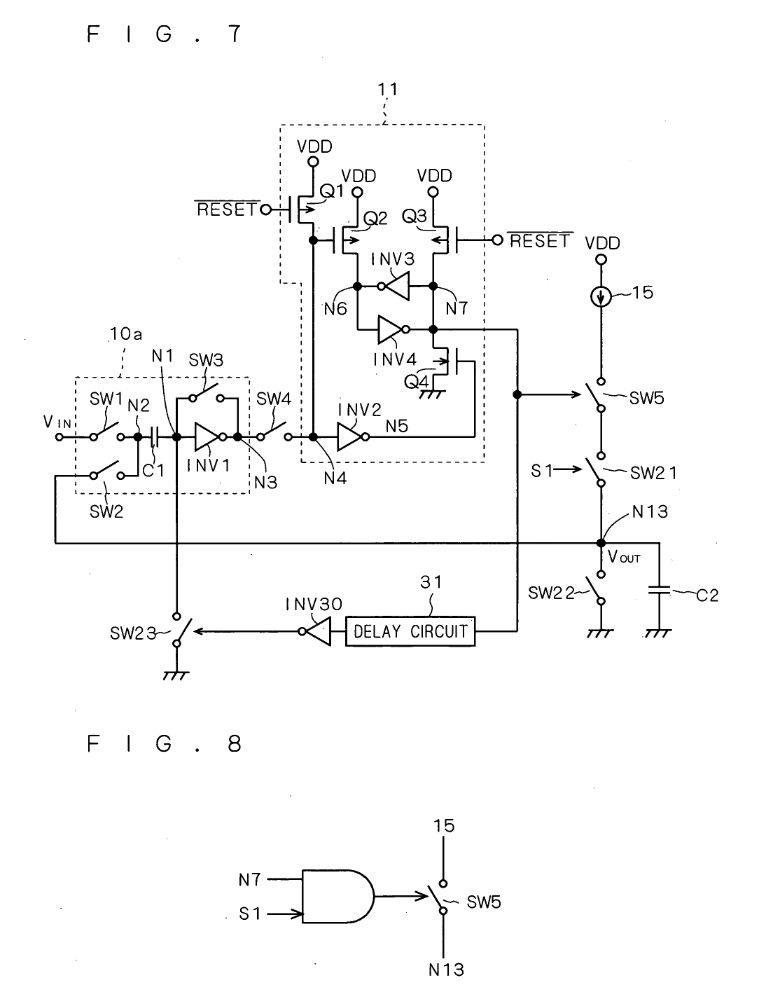

FIG. 7 is a circuit diagram illustrating the configuration of the liquid crystal driving circuit 109 according to a fourth preferred embodiment of the invention. For ease of description, the case of charging the potential at the output node N13 (output voltage V_{OUT}) from a ground potential (e.g., VSS) to an input voltage V_{IN} will be described with reference to FIG. 7.

As illustrated in FIG. 7, the liquid crystal driving circuit 109 according to the fourth preferred embodiment includes switches SW21 to SW23, a delay circuit 31 and an inverter INV30 as well as the comparator 10a, latch circuit 11, constant current source 15 and switches SW4 and SW5 as described in the first preferred embodiment. Since FIG. 7 is illustrated to represent the case of charging the potential at the output node N13 from the ground potential to the input voltage V_{IN}, the latch circuit 12, AND circuit 13, NOR circuit 14, constant current source 16 and switches SW6 to SW8 illustrated in FIG. 2 are not necessary.

The switch SW21 is connected between the switch SW5 and output node N13. The turning on/off of the switch SW21 is controlled by a control signal S1. The switch SW22 is connected between the output node N13 and ground potential. The delay circuit 31 is connected to the node N7. The inverter INV30 has an input terminal connected to the delay circuit 31 and an output terminal connected to the switch SW23. The switch SW23 is connected between the node N1 and ground potential.

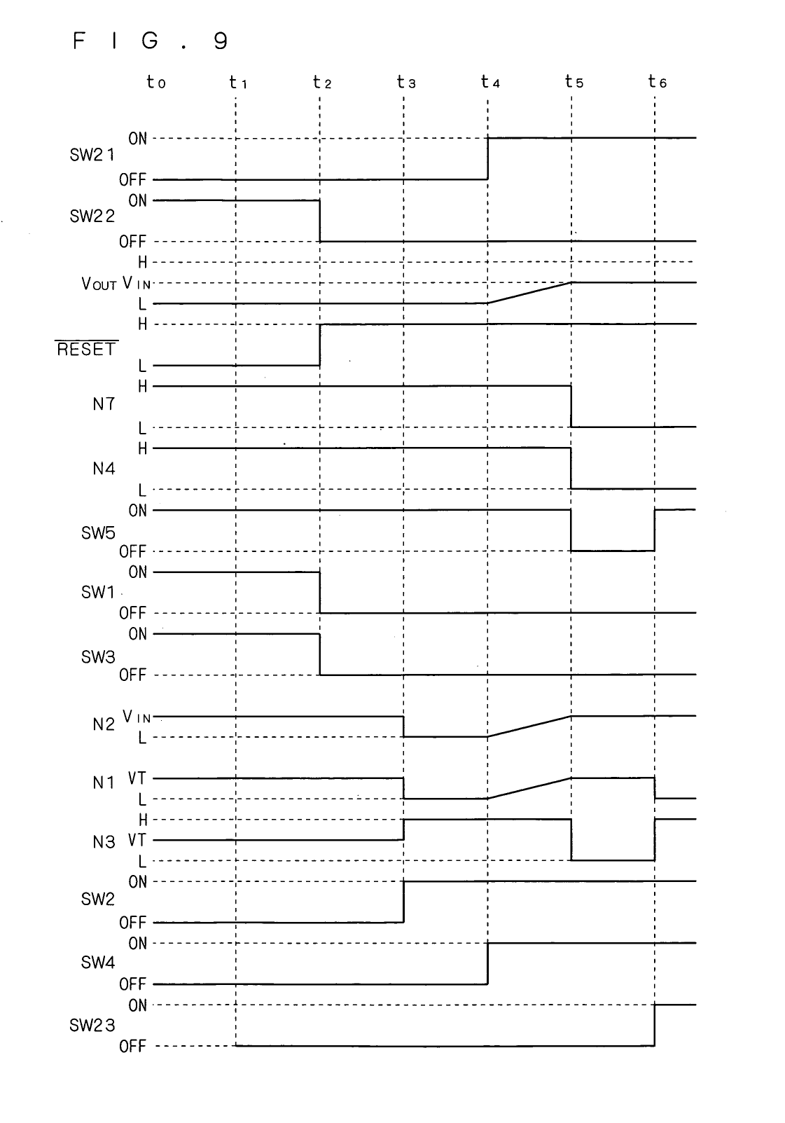

FIG. 8 is a circuit diagram illustrating the configuration of part of the liquid crystal driving circuit 109 according to a variant of the fourth preferred embodiment. The switch SW21 illustrated in FIG. 7 may be replaced by an AND circuit having a first input terminal connected to the node N7, a second input terminal for receiving the control signal S1 and an output terminal connected to the switch SW5, as illustrated in FIG. 8.

FIG. 9 is a timing chart illustrating an operation of the liquid crystal driving circuit 109 illustrated in FIG. 7. Referring to FIGS. 7 and 9, at time t0, the switch SW21 is turned off, and the switch SW22 is turned on. The logic level of the most significant bit D5 of display data SIG which is 6-bit digital data illustrated in FIG. 1, for example, is detected. When the logic level of the most significant bit D5 is LOW, the switch SW21 is turned off, and the switch SW22 is turned on. As a result, the potential at the output node N13 transitions to LOW.

Further, at time t0, the latch circuit 11 is reset by applying an “L” reset signal \overline{RESET}. As a result, the potential at each of the nodes N4 and N7 transitions to HIGH, while the potential at the node N5 transitions to LOW. The PMOS transistor Q3 is turned on, and the NMOS transistor Q4 is turned off. Thus, the potential at the node N7 transitions to HIGH, turning on the switch SW5. The HIGH potential at the node N7 is transmitted to the inverter INV30 through the delay circuit 31 and is reversed to LOW in the inverter INV30. As a result, the switch SW23 is turned off at time t1.

Furthermore, at time t0, the switches SW1 and SW3 are turned on. As a result, the potential at the node N2 transitions to the input voltage V_{IN}, and the potential at each of the nodes N1 and N3 transitions to the threshold voltage VT of the inverter INV1.

At time t2, the switches SW1, SW3 and SW22 are turned off, and the reset signal RESET transitions to HIGH. The reset signal RESET may transition to HIGH before time t2, providing that the latch circuit 11 is reset with reliability.

Next, at time t3, the switch SW2 is turned on. Then, the potential at the node N2 transitions from the input voltage V_{IN} to the LOW potential at the output node N13. As a result, the capacitive coupling of the capacitive element C1 causes the potential at the node N1 to drop by V_{IN} minus V_{OUT}. As a result, the input voltage to the inverter INV1 becomes lower than the threshold voltage VT, causing the potential at the node N3 to transition to HIGH.

Next, at time t4, the switches SW4 and SW21 are turned on. With the turning on of the switch SW21, the constant current source 15 and output node N13 are connected through the switches SW5 and SW21. Accordingly, the output node N13 is charged through the constant current source 15, causing the potential at the output node N13 (output voltage V_{OUT}) to gradually rise. With the turning on of the switch SW4, the potential at the node N4 does not vary but remains HIGH.

At time t5, when the output voltage V_{OUT} rises to reach the input voltage V_{IN}, the potential at the node N1 transitions to the threshold voltage VT, causing the output from the inverter INV1 to be reversed, so that the potential at each of the nodes N3 and N4 transitions to LOW. Then, the potential at the node N5 transitions to HIGH, causing the output from the latch circuit 11 to be reversed, so that the potential at the node N7 transitions to LOW. As a result, the switch SW5 is turned off, so that the charging at the output node N13 is stopped.

At this time, a short circuit current flows through the inverter INV1 as the potential at the node N1 is the threshold voltage VT. That is, power is consumed at the inverter INV1.

The LOW potential at the node N7 is transmitted to the inverter INV30 through the delay circuit 31, and is reversed to HIGH by the inverter INV30. As a result, at time t6, the switch SW23 is turned on. With the turning on of the switch SW23, the potential at the node N1 transitions to LOW, causing no short circuit current to flow through the inverter INV1. That is, power consumption in the inverter INV 1 is stopped.

With the transition of the potential at the node N1 to LOW, the potential at each of the nodes N3 and N4 transitions to HIGH, and the potential at the node N5 transitions to LOW, however, the output from the latch circuit 11 is not reversed, and the potential at the node N7 remains LOW. Accordingly, the switch SW5 is held off, so that the output voltage V_{OUT} does not vary.

The reason for providing the delay circuit 31 is to cause the potential at the node N1 to transition to LOW after ensuring that the switch SW5 is turned off after the potential at the node N7 transitions to LOW. In the case where the switch SW5 is turned off immediately after the potential at the node N7 transitions to LOW, there is no need to provide the delay circuit 31.

The above description has been directed to the case of charging the potential at the output node N13 from the ground potential to the input voltage V_{IN}, however, a discharge circuit may be connected to the output node N13 so that the potential at the output node N13 can transition from the source potential VDD to the input voltage V_{IN}. Off course, the invention according to the fourth preferred embodiment is also applicable to the above-described first to third preferred embodiments.

According to the liquid crystal display 100 of the present embodiment, setting the potential at the node N1 at LOW just after setting the voltage of the data line DL (output voltage V_{OUT}) equal to the input voltage V_{IN} allows no short circuit current to flow through the inverter INV1, so that power consumption in the comparator 10a is stopped. Accordingly, power consumption can be reduced as compared to the case where a short circuit current continues to flow through the inverter INV1 after the writing in the data line DL is finished (e.g., the above-mentioned JP2004-166039).

### Fifth Preferred Embodiment

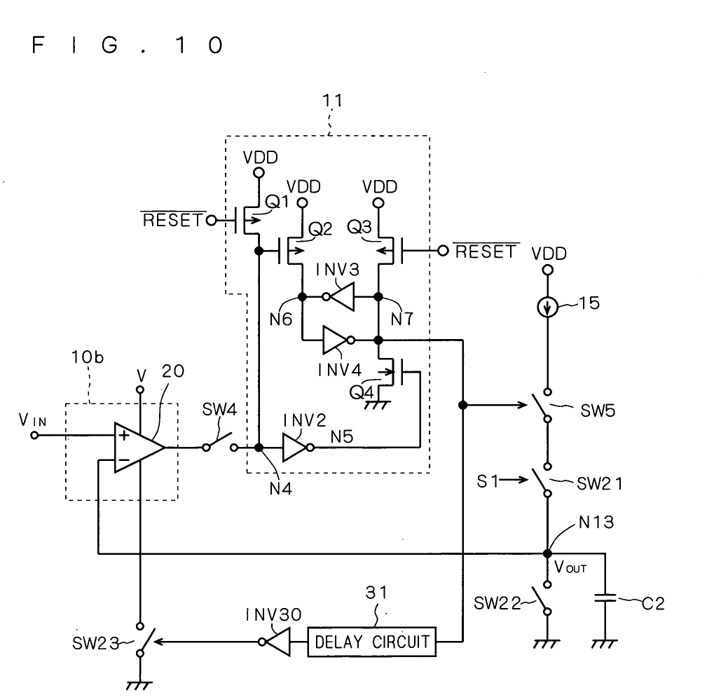

FIG. 10 is a circuit diagram illustrating the configuration of the liquid crystal driving circuit 109 according to a fifth preferred embodiment of the invention. As illustrated in FIG. 10, the liquid crystal driving circuit 109 includes the comparator 10b as well as the delay circuit 31, inverter INV30, latch circuit 11, constant current source 15 and switches SW4, SW5, SW21 to SW23 as described in the fourth preferred embodiment. The comparator 10b according to the present embodiment has similar functions as the comparator 10a according to the fourth preferred embodiment.

The comparator 10b has the differential amplifier 20. The differential amplifier 20 has a first input terminal (+side) connected to a terminal for receiving the input voltage V_{IN}, a second input terminal (− side) connected to the output node N13 and an output terminal connected to the switch SW4.

The switch SW23 is provided at any position along a power-supply path between a high potential source V and a low potential source in the differential amplifier 20. In the example illustrated in FIG. 10, the switch SW23 is connected between the differential amplifier 20 and low potential source. The switch SW23 is turned off just after the voltage of the data line DL is set equal to the input voltage V_{IN}, so that the power-supply path of the differential amplifier 20 is cut off. Therefore, power consumption in the comparator 10b is stopped.

According to the liquid crystal display 100 of the present embodiment, the use of the differential amplifier 20 in the comparator 10b can reduce the number of switches as compared to the fourth preferred embodiment using the switched comparator 10a. Therefore, the control circuit for controlling switches can be made simpler in configuration.

### Sixth Preferred Embodiment

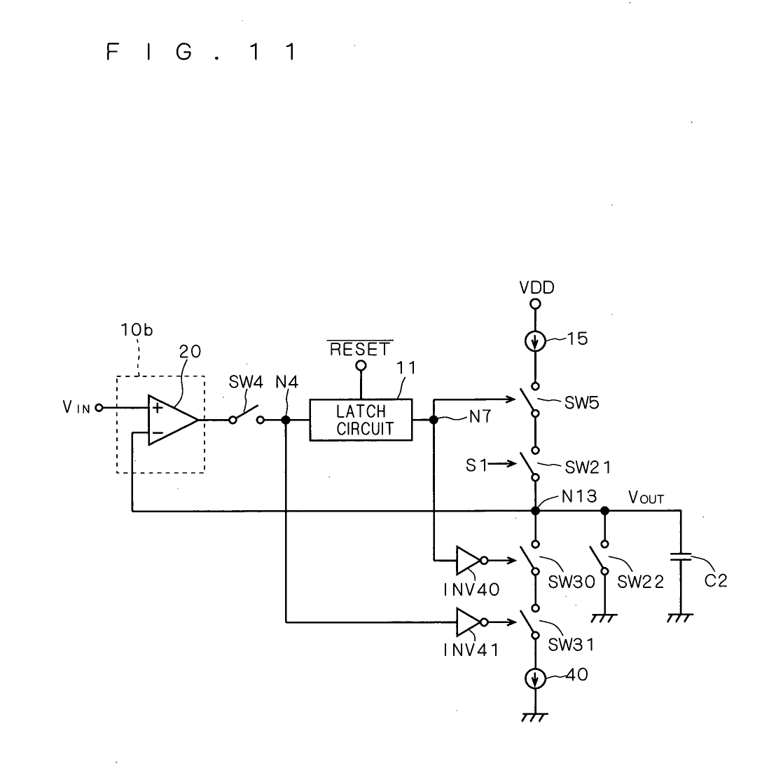

FIG. 11 is a circuit diagram illustrating the configuration of the liquid crystal driving circuit 109 according to a sixth preferred embodiment of the invention. For ease of description, the case of charging the potential at the output node N13 (output voltage V_{OUT}) from a ground potential (e.g., VSS) to an input voltage V_{IN} will be described with reference to FIG. 11.

As illustrated in FIG. 11, the liquid crystal driving circuit 109 according to the sixth preferred embodiment includes switches SW21, SW22, SW30, SW31, inverters INV40, INV41 and a constant current source 40 as well as the comparator 10b, latch circuit 11, constant current source 15 and switches SW4 and SW5 as described in the second preferred embodiment. Since FIG. 11 is illustrated to represent the case of charging the potential at the output node N13 from the ground potential to the input voltage V_{IN}, the latch circuit 12, AND circuit 13, NOR circuit 14, constant current source 16 and switches SW6 to SW8 illustrated in FIG. 5 are not necessary.

The switch SW21 is connected between the switch SW5 and output node N13. The turning on/off of the switch SW21 is controlled by the control signal S1. The switch SW22 is connected between the output node N13 and ground potential. The switch SW30 is connected to the output node N13. The switch SW31 is connected between the switch SW30 and constant current source 40. The constant current source 40 is connected between the switch SW31 and ground potential. The inverter INV40 has an input terminal connected to the node N7 and an output terminal connected to the switch SW30. The inverter INV41 has an input terminal connected to the node N4 and an output terminal connected to the switch SW31. The current value of the constant current source 40 is set at, for example, about one-tenth of that of the constant current source 15.

An operation of the liquid crystal driving circuit 109 according to the present embodiment will now be described. First, similarly to the fourth preferred embodiment, the switch SW21 is turned off, and the switch SW22 is turned on. As a result, the potential at the output node N13 (output voltage V_{OUT}) transitions to LOW. Next, the switches SW4 and SW21 are turned on. The comparator 10b compares the input voltage V_{IN} and output voltage V_{OUT}. Since the output voltage V_{OUT} is LOW, V_{OUT}<V_{IN} holds, and the comparator 10b outputs an “H” signal. Since the switch SW4 is on, the potential at the node N4 transitions to HIGH.

Here, the latch circuit 11 is previously reset by applying an “L” reset signal \overline{RESET}, causing the potential at the node N7 to transition to HIGH, so that the switch SW5 is on. Since the switches SW5 and SW21 are both on, the output node N13 is charged through the constant current source 15, causing the output voltage V_{OUT} to gradually rise. Since the switches SW30 and SW31 are both held off at this time, the output node N13 is not discharged through the constant current source 40.

When the output voltage V_{OUT} rises to reach the input voltage V_{IN}, the output from the comparator 10b becomes LOW, causing the output from the latch circuit 11 to be reversed, so that the potential at the node N7 transitions to LOW. As a result, the switch SW5 is turned off, so that the charging at the output node N13 is stopped. There is a slight time delay developed by the comparison operation of the comparator 10b from the point of time when the output voltage V_{OUT} rises to reach the input voltage V_{IN} to the point of time when the switch SW5 is turned off. That is, a time delay in the comparator 10b causes the output voltage V_{OUT} to be charged excessively.

The LOW potential at the node N7 is reversed to HIGH by the action of the inverters INV40 and INV41, so that the switches SW30 and SW31 are turned on. As a result, the output voltage V_{OUT} charged excessively is gradually discharged through the constant current source 40. When the output voltage V_{OUT} drops to reach the input voltage V_{IN}, the output from the comparator 10b becomes HIGH, resulting in the turn-off of the switch SW31, so that the discharging at the output node N13 is stopped. Even when the output from the comparator 10b becomes HIGH, the output from the latch circuit 11 is not reversed, so that the switch SW5 is held off, and the switch SW30 is held on.

Similarly to the above description, there is a slight time delay developed from the point of time when the output voltage V_{OUT} drops to the input voltage V_{IN} to the point of time when the switch SW31 is turned off. That is, a time delay in the comparator 10b causes the output voltage V_{OUT} to be discharged excessively. However, the current value of the constant current source 40 is set at about one-tenth of that of the constant current source 15. Accordingly, the difference between the input voltage V_{IN} and output voltage V_{OUT} resulting from the excessive discharging through the constant current source 40 is reduced to about the ratio of current values (1/10) as compared to the difference between the input voltage V_{IN} and output voltage V_{OUT} resulting from the excessive charging through the constant current source 15.

In the case of compensating for the voltage difference resulting from the excessive discharging through the constant current source 40, a charging circuit (not shown) including a new constant current source with a current value set at about one-tenth of that of the constant current source 40 may be added so that the excessively discharged voltage through the constant current source 40 can be recharged by this charging circuit. Accordingly, the difference between the input voltage V_{IN} and output voltage V_{OUT} can be made still smaller.

The above description has been directed to the case of discharging the excessively charged voltage after charging the potential at the output node N13 from the ground potential. In contrast, it is possible to charge the excessively discharged voltage by the charging circuit after discharging the potential at the output node N13 from the source potential VDD by the discharging circuit. Off course, the invention according to the sixth preferred embodiment is also applicable to the first to fifth preferred embodiments.

According to the liquid crystal display 100 according to the present embodiment, the constant current source 15 for charging is disconnected from the output node N13 by turning off the switch SW5, and thereafter, the constant current source 40 for discharging and output node N13 are connected by the turning-on of the switches SW30 and SW31. Accordingly, the excessively charged voltage through the constant current source 15 can be discharged through the constant current source 40.

Further, since the current value of the constant current source 40 is set lower than that of the constant current source 15, the offset voltage between the input voltage V_{IN} and output voltage V_{OUT} resulting from the excessive discharging through the constant current source 40 can be made lower than the offset voltage resulting from the excessive charging through the constant current source 15.

### Seventh Preferred Embodiment

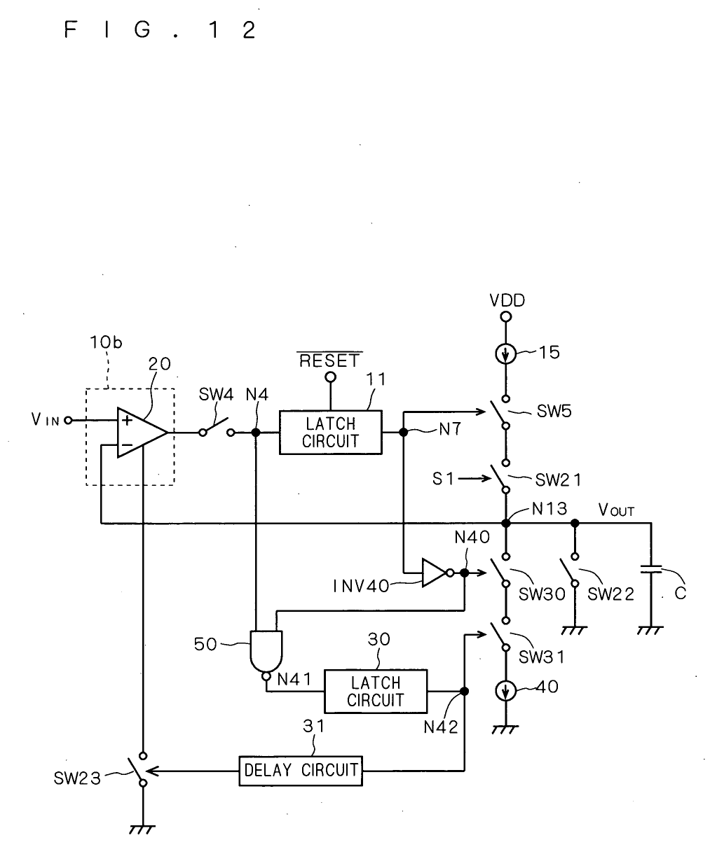

A combination of the fifth and sixth preferred embodiments will be described in this embodiment. FIG. 12 is a circuit diagram illustrating the configuration of the liquid crystal driving circuit 109 according to the seventh preferred embodiment of the invention. A NAND circuit 50 has a first input terminal connected to the node N4 and a second input terminal connected to a node N40 which is the output terminal of the inverter INV40. The latch circuit 30 is connected between a node N42 and a node N41 which is the output terminal of the NAND circuit 50. The delay circuit 31 is connected between the node N42 and switch SW23. The other configuration of the liquid crystal driving circuit 109 according to the present embodiment is similar to those of the fifth and sixth preferred embodiments.

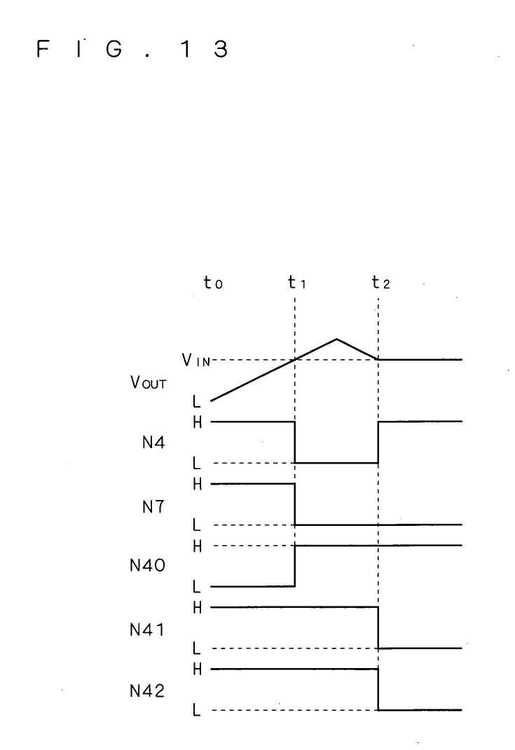

FIG. 13 is a timing chart illustrating an operation of the liquid crystal driving circuit 109 illustrated in FIG. 12. Referring to FIGS. 12 and 13, by previously turning off the switch SW21 and turning on the switch SW22, the potential at the output node N13 (output voltage V_{OUT}) is set LOW. At time t0, the switches SW4 and SW21 are turned on, causing the potential at the node N4 to transition to HIGH. The latch circuit 11 is reset by applying an “L” reset signal \overline{RESET}, causing the potential at the node N7 to transition to HIGH. Accordingly, the output node N13 is charged through the constant current source 15, causing the output voltage V_{OUT} to gradually rise. At this time, the potential at the node N40 transitions to LOW, and the potential at each of the nodes N41 and N42 transitions to HIGH. Since the switch SW30 is held off by the LOW potential at the node N40, the output node N13 is not discharged through the constant current source 40.

Next, at time t1, when the output voltage V_{OUT} rises to reach the input voltage V_{IN}, the output from the comparator 10b becomes LOW, causing the output from the latch circuit 11 to be reversed, so that the potential at the node N7 transitions to LOW. As a result, the switch SW5 is turned off, so that the charging at the output node N13 is stopped. As described in the sixth preferred embodiment, the output voltage V_{OUT} is excessively charged due to the time delay in the comparator 10b. Since the potential at the node N40 transitions to HIGH, the switch SW30 is turned on. As a result, the excessively charged output voltage V_{OUT} is gradually discharged through the constant current source 40.

Next, at time t3, when the output voltage V_{OUT} drops to the input voltage V_{IN}, the output from the comparator 10b becomes HIGH, causing the potential at the node N41 to transition from HIGH to LOW. Accordingly, the output from the latch circuit 30 is reversed to cause the potential at the node N42 to transition to LOW, turning off the switch SW31, so that the discharge at the output node N13 is stopped.

The LOW potential at the node N42 is transmitted to the switch SW23 through the delay circuit 31. As a result, the switch SW23 is turned off, causing the power-supply path of the differential amplifier 20 to be cut off, so that power consumption in the comparator 10b is stopped.

Even when the comparator 10b is deactivated to make an output undefined, the potentials at the nodes N7, N40 and N42 are maintained by the latch circuits 11 and 30. Therefore, the state of the switches SW5, SW30 and SW31 do not change.

### Eighth Preferred Embodiment

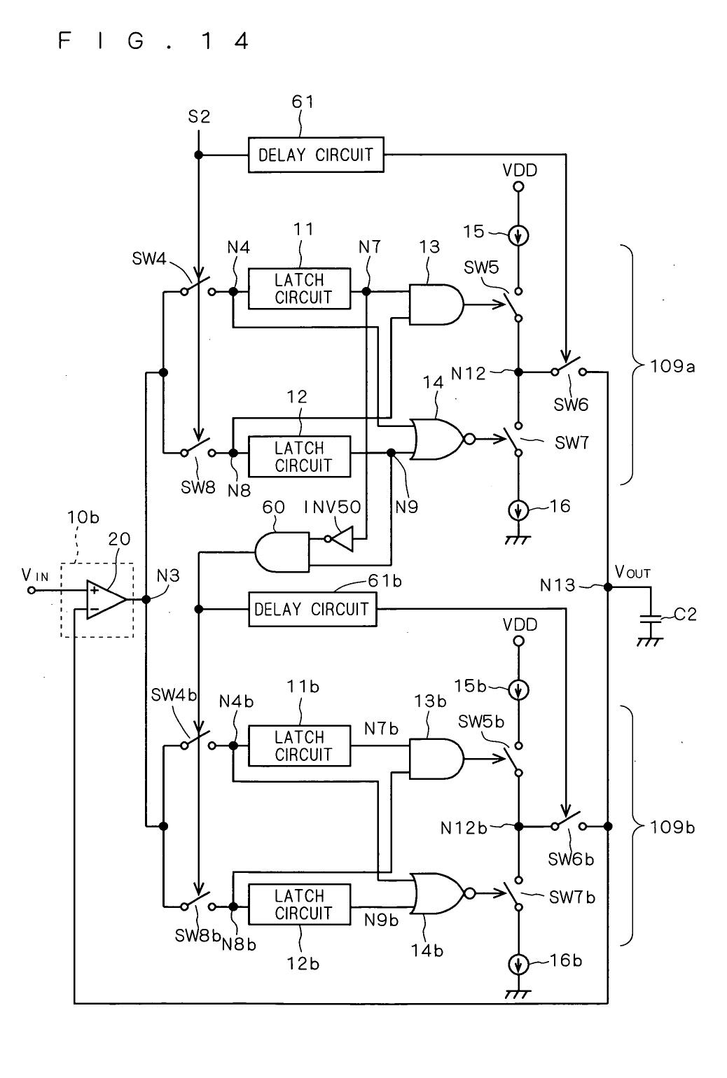

A combination of the second and sixth preferred embodiments will be described in the present embodiment. FIG. 14 is a circuit diagram illustrating the configuration of the liquid crystal driving circuit 109 according to the eighth preferred embodiment of the invention. As illustrated in FIG. 14, the liquid crystal driving circuit 109 includes an upper driving circuit 109a corresponding to the liquid crystal driving circuit illustrated in FIG. 5 and a lower driving circuit 109b configured similarly to the upper driving circuit 109a.

In the upper driving circuit 109a, the turning on/off of the switches SW4 and SW8 is controlled by a control signal S2. The turning on/off of the switch SW6 is controlled by the control signal S2 delayed by a delay circuit 61.

The lower driving circuit 109b includes latch circuits 11b, 12b, an AND circuit 13b, a NOR circuit 14b, constant current sources 15b, 16b and switches SW4b to SW8b. The respective components of the lower driving circuit 109b are connected similarly to the upper driving circuit 109a, detailed explanation of which is thus omitted here.

The liquid crystal driving circuit 109 according to the present embodiment further includes an inverter INV50 and an AND circuit 60. The inverter INV50 has an input terminal connected to the node N7. The AND circuit 60 has a first input terminal connected to the output terminal of the inverter INV50, a second input terminal connected to the node N9 and an output terminal connected to the switches SW4b, SW8b and a delay circuit 61b. The delay circuit 61b is connected to the switch SW6b.

The current value of the constant current source 15 is set greater than that of the constant current source 16b. Similarly, the current value of the constant current source 16 is set greater than that of the constant current source 15b. The current values of the constant current sources 15 and 16 are set almost equal to each other, while the current values of the constant current sources 15b and 16b are set almost equal to each other.

In the liquid crystal driving circuit 109 according to the present embodiment, charging/discharging of the data line DL is performed by the upper driving circuit 109a using the voltage written in the data line DL in the immediately preceding write cycle, and thereafter, the excessively-charged or excessively-discharged voltage by the upper driving circuit 109a is discharged or charged by the lower driving circuit 109b. More specifically, the excessively-charged voltage through the constant current source 15 is discharged through the constant current source 16b, and the excessively-discharged voltage through the constant current source 16 is charged through the constant current source 15b. Accordingly, the offset voltage between the input voltage V_{IN} and output voltage V_{OUT} resulting from the excessive charging or excessive discharging is reduced.

The operation of the upper driving circuit 109a is finished when the outputs from the latch circuits 11 and 12 are both reversed. Therefore, activation of the lower driving circuit 109b is controlled by calculating a logic product of the potential at the node N7 (output from the latch circuit 11) reversed at the inverter INV50 and the potential at the node N9 (output from the latch circuit 12).

Additionally providing a circuit (configured similarly to the lower driving circuit 109b) for compensating for the excessive charging/discharging by the lower driving circuit 109b, the offset voltage between the input voltage V_{IN} and output voltage V_{OUT} can be made still lower.

### Ninth Preferred Embodiment

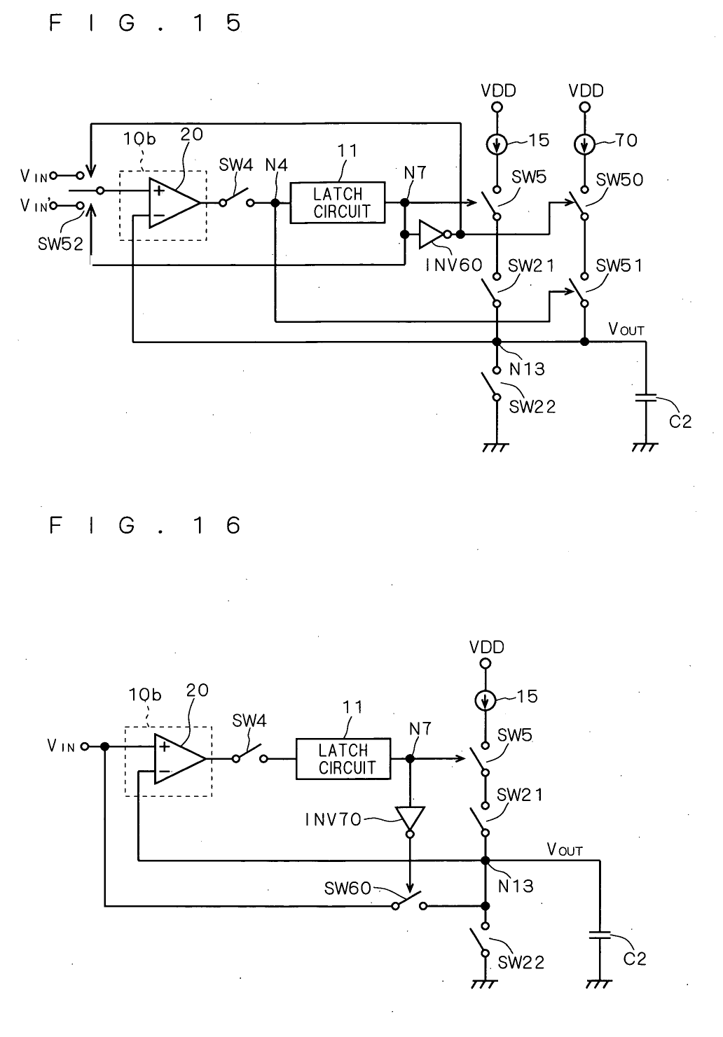

FIG. 15 is a circuit diagram illustrating the configuration of the liquid crystal driving circuit 109 according to a ninth preferred embodiment of the invention. For ease of description, the case of charging the potential at the output node N13 (output voltage V_{OUT}) from a ground potential (e.g., VSS) to an input voltage V_{IN} will be described with reference to FIG. 15.

As illustrated in FIG. 15, the liquid crystal driving circuit 109 according to the ninth preferred embodiment includes the comparator 10b, latch circuit 11, constant current sources 15, 70, inverter INV60 and switches SW5, SW21, SW22 and SW50 to SW52.

The constant current source 70 is connected to the source potential VDD. The switch SW50 is connected between the constant current source 70 and switch SW51. The switch SW51 is connected between the switch SW50 and output node N13. The inverter INV60 has an input terminal connected to the node N7 and an output terminal connected to the switch SW50. The switch SW52 switches between the input voltage V_{IN} and input voltage V_{IN}′. The input voltage V_{IN}′ is, for example, one gradation level lower than the input voltage V_{IN}, but is not limited to such level, and may be set at an appropriate voltage depending on the time delay in the comparator 10b. The current value of the constant current source 70 is set at, for example, about one-tenth of that of the constant current source 15.

An operation of the liquid crystal driving circuit 109 according to the present embodiment will now be described. First, the switch SW21 is turned off, and the switch SW22 is turned on, so that the potential at the output node N13 (output voltage V_{OUT}) is set LOW. Resetting the latch circuit 11, the potential at the node N7 transitions to HIGH, so that the switch SW5 is turned on, and the switch SW50 is turned off. The switch SW52 is switched to the input voltage V_{IN}′ side.

Next, the switch SW22 is turned off, and then the switches SW4 and SW21 are turned on, so that the output node N13 is charged through the constant current source 15, causing the output voltage V_{OUT} to gradually rise. When the output voltage V_{OUT} reaches the input voltage V_{IN}′, the output from the comparator 10b becomes LOW, causing the output from the latch circuit 11 to be reversed, so that the potential at the node N7 transitions to LOW. As a result, the switch SW5 is turned off, so that the charging at the output node N13 through the constant current source 15 is stopped. The potential at the node N7 is reversed at the inverter INV60, so that the switch SW50 is turned on.

In response to the transition of the potential at the node N7 to LOW, the switch SW52 is switched to the input voltage V_{IN} side. Since V_{OUT}<V_{IN} holds at this time, the output from the comparator 10b transitions from LOW to HIGH. As a result, the switch SW51 is turned on. On the other hand, the output from the latch circuit 11 is not reversed even when the output from the comparator 10b transitions from LOW to HIGH, causing the switch SW50 to be held on.

Since the switches SW50 and SW51 are both on, charging at the output node N13 through the constant current source 70 is started, causing the potential at the output node N13 to gradually rise from V_{IN}′+Δ (where Δ represents the offset voltage resulting from the time delay in the comparator 10b) toward V_{IN}.

When the output voltage V_{OUT} rises to reach the input voltage V_{IN}, the output from the comparator 10b becomes LOW. As a result, the switch SW51 is turned off, so that the charging at the output node N13 through the constant current source 70 is stopped.

In the case of further reducing the offset voltage, a constant current source with a current value set still lower than that of the constant current source 70 may be added so that charging of the data line DL up to the input voltage V_{IN} can be performed through the added constant current source.

The above description has been directed to the case of charging the potential at the output node N13 from the ground potential to the input voltage V_{IN}, however, a discharge circuit may be connected to the output node N13 such that the potential at the output node N13 is discharged from the source potential VDD to the input voltage V_{IN}. Off course, the invention according to the ninth preferred embodiment is also applicable to the above-described first to eighth preferred embodiments.

According to the liquid crystal display 100 according to the present embodiment, charging through the constant current source 15 is stopped when the output voltage V_{OUT} reaches the input voltage V_{IN}′ (<V_{IN}), and thereafter, charging through the constant current source 70 is performed until the output voltage V_{OUT} reaches the input voltage V_{IN}. Since the current value of the constant current source 70 is set lower than that of the constant current source 15, the offset voltage resulting from the low-speed charging through the constant current source 70 is lower than the offset voltage resulting from the high-speed charging through the constant current source 15. Therefore, the offset voltage resulting from the time delay in the comparator 10b can be reduced as compared to the case of performing charging through the constant current source 15 until the output voltage V_{OUT} reaches the input voltage V_{IN}.

### Tenth Preferred Embodiment

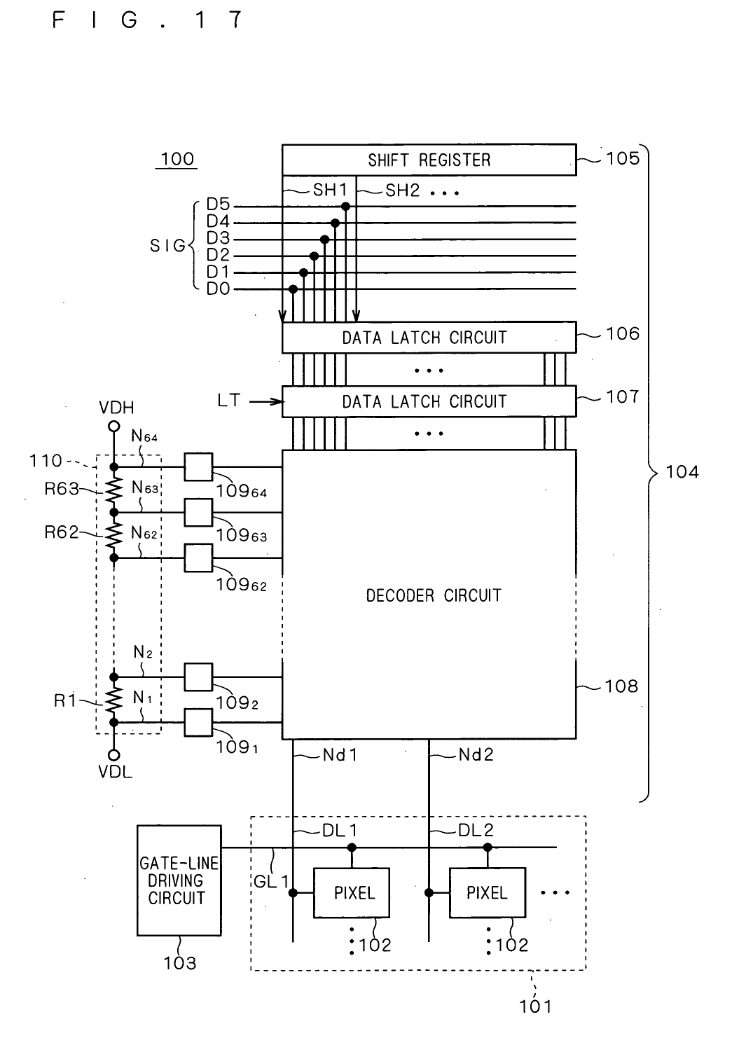

FIG. 16 is a circuit diagram illustrating the configuration of the liquid crystal driving circuit 109 according to a tenth preferred embodiment of the invention. For ease of description, the case of charging the potential at the output node N13 (output voltage V_{OUT}) from a ground potential (e.g., VSS) to an input voltage V_{IN} will be described with reference to FIG. 16.

As illustrated in FIG. 16, the liquid crystal driving circuit 109 according to the present embodiment includes the comparator 10b, latch circuit 11, constant current source 15, inverter INV70 and switches SW5, SW21, SW22 and SW60.

The inverter INV70 has an input terminal connected to the node N7 and an output terminal connected to the switch SW60. The switch SW60 is connected between a terminal for receiving the input voltage V_{IN} and the output node N13.

An operation of the liquid crystal driving circuit 109 according to the present embodiment will now be described. First, the switch SW21 is turned off, and the switch SW22 is turned on, so that the potential at the output node N13 (output voltage V_{OUT}) is set LOW. Resetting the latch circuit 11, the potential at the node N7 transitions to HIGH, so that the switch SW5 is turned on, and the switch SW60 is turned off.

Next, the switch SW22 is turned off, and then the switches SW4 and SW21 are turned on, so that the output node N13 is charged through the constant current source 15, causing the output voltage V_{OUT} to gradually rise. When the output voltage V_{OUT} reaches the input voltage V_{IN}, the output from the comparator 10b becomes LOW, causing the output from the latch circuit 11 to be reversed, so that the potential at the node N7 transitions to LOW. As a result, the switch SW5 is turned off, so that the charging at the output node N13 through the constant current source 15 is stopped.

The LOW potential at the node N7 is reversed at the inverter INV70, so that the switch SW60 is turned on. With the turning-on of the switch SW60, the output node N13 is shorted to the input voltage V_{IN}. As a result, the output voltage V_{OUT} having been charged excessively due to the time delay in the comparator 10b drops toward the input voltage V_{IN}. Usually, the gradation voltage generating circuit 110 (FIG. 1) for generating the input voltage V_{IN} has such a high output impedance that it is difficult to charge the output node N13 by means of the input voltage V_{IN}, if applied to the output node N13, within a predetermined time period. In the present embodiment, however, the output voltage V_{OUT} only needs to be varied by the offset voltage with the input voltage V_{IN}, which allows the output node N13 to be charged by means of the input voltage V_{IN}.

Although the switching of the switch SW60 is controlled by the output from the latch circuit 11 in the example illustrated in FIG. 16, but may be controlled by the input to the latch circuit 11 (i.e., the output from the comparator 10b). In that case, the switch SW60 can be turned on immediately when the output from the comparator 10b transitions to LOW. Accordingly, the offset voltage is reduced as the processing in the latch circuit 11 is not involved, which can reduce a time required for dropping the output voltage V_{OUT} by means of the input voltage V_{IN}.

The above description has been directed to the case of charging the potential at the output node N13 from the ground potential to the input voltage V_{IN}, however, a discharge circuit may be connected to the output node N13 so that the potential at the output node N13 can be discharged from the source potential VDD to the input voltage V_{IN}. Off course, the invention according to the tenth preferred embodiment is also applicable to the above-described first to ninth preferred embodiments.

According to the liquid crystal display 100 of the present embodiment, the switch SW60 is turned on immediately after the charging through the constant current source 15 is stopped, so that the output node N13 is shorted to the input voltage V_{IN}. This allows the output node N13 to be directly charged by means of the input voltage V_{IN}, so that the offset voltage resulting from the time delay in the comparator 10b can be reduced.

### Eleventh Preferred Embodiment

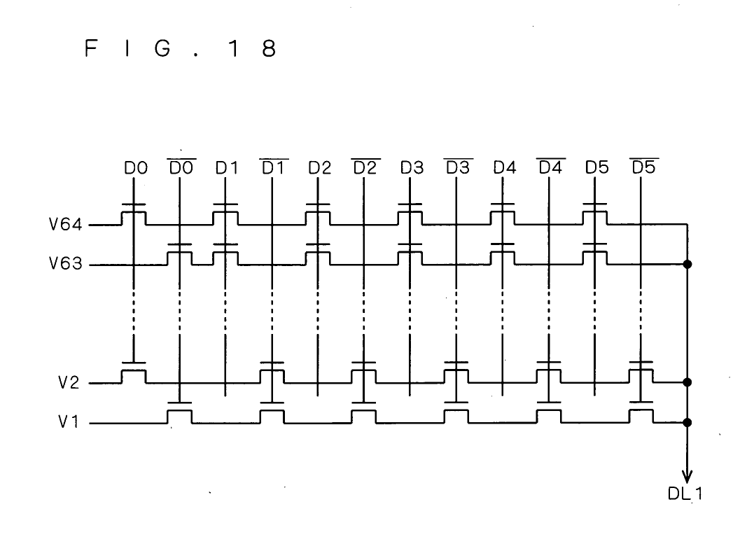

FIG. 17 is a block diagram illustrating the overall configuration of the liquid crystal display 100 according to an eleventh preferred embodiment of the invention. The source driver 104 according to the present embodiment has the shift register 105, data latch circuits 106, 107, gradation voltage generating circuit 110, decoder circuit 108 and driving circuits 109₁ to 109₆₄. The driving circuits 109₁ to 109₆₄ are provided for the gradation voltage nodes N₁ to N₆₄, respectively. Each of the driving circuits 109₁ to 109₆₄ is configured similarly to the liquid crystal driving circuit 109 described in the first to tenth preferred embodiments. More specifically, this eleventh preferred embodiment applies the inventions according to the first to tenth preferred embodiments to the gradation voltage generating circuit 110 while omitting the liquid crystal driving circuit 109 provided for each data line DL. Since a gradation voltage source needs to have the function of flowing and receiving an output current, the circuit according to the seventh preferred embodiment illustrated in FIG. 12 is most suitable for the driving circuits 109, to ¹⁰⁹⁴.

FIG. 18 is a circuit diagram illustrating the configuration of part of the decoder circuit 108 illustrated in FIG. 17 giving attention to the data line DL1. Circuit similar to that of FIG. 18 is used for other data lines DL. FIG. 18 illustrates an example in which 64 levels of gradation voltages V1 to V64 are decoded by 6-bit display data bits D0 to D5. Each gradation voltage is selected when six NMOS transistors connected in series are all turned on. Each of the NMOS transistors serves as a switching element, and outputs a voltage equal to a gradation voltage selected by the display data bits D0 to D5, to the data line DL1.

According to the liquid crystal display 100 of the present embodiment, the following effects can be achieved in addition to those obtained by the first to tenth preferred embodiments. More specifically, in the case where the liquid crystal driving circuit 109 is provided individually for each data line DL, variations in characteristics of respective liquid crystal driving circuits 109 result in a voltage deviation in respective data lines DL even when a voltage of the same level is written in all the data lines DL, which may cause color irregularity on a display screen. In contrast, in the case of configuring the gradation voltage source as in the present embodiment, a voltage to be output to each data line DL is supplied from the same gradation voltage source, which causes no voltage deviation in respective data lines DL. As a result, color irregularity on a display screen can be improved.

The first to eleventh preferred embodiments of the present invention have been described using the liquid crystal display 100 as an example, however, the present invention is not limited to such liquid crystal display, but is also applicable to a display apparatus having field emission display devices such as an organic electroluminescence display.

While the invention has been shown and described in detail, the foregoing description is in all aspects illustrative and not restrictive. It is therefore understood that numerous modifications and variations can be devised without departing from the scope of the invention.

What is claimed is:

1. A display apparatus comprising:
a pixel having a voltage-driven display device;
a signal line serving as a data line connected to said pixel; and
a driving circuit for receiving gradation voltages corresponding to display data, each being received as an input voltage, and writing an output voltage based on said input voltage into said signal line, wherein
said driving circuit includes:
a first charging circuit and a first discharging circuit, each being selectively connected to said signal line; and
a comparator for comparing said input voltage input in a current write cycle with a voltage of said signal line set in a preceding write cycle, and
one of said first charging circuit and said first discharging circuit is connected to said signal line based on a result of comparison made by said comparator, to thereby set said voltage of said signal line at said input voltage.

2. The display apparatus according to claim 1, wherein
said driving circuit further includes:
switching circuits, one being connected between said signal line and said first charging circuit and the other being connected between said signal line and said first discharging circuit; and
switching control circuits for controlling said switching circuits, respectively, based on a result of comparison made by said comparator.

3. The display apparatus according to claim 1, further comprising
a circuit for reducing power consumption in said comparator after said voltage of said signal line is set equal to said input voltage.

4. The display apparatus according to claim 1, wherein
said driving circuit further includes a second discharging circuit selectively connected to said signal line, and
said second discharging circuit is connected to said signal line after said first charging circuit is disconnected from said signal line, to thereby set said voltage of said signal line having been charged excessively by said first charging circuit, at said input voltage.

5. The display apparatus according to claim 1, wherein
said driving circuit further includes a second charging circuit selectively connected to said signal line, and
said second charging circuit is connected to said signal line after said first discharging circuit is disconnected from said signal line, to thereby set said voltage of said signal line having been discharged excessively by said first discharging circuit, at said input voltage.

6. The display apparatus according to claim 1, wherein
said driving circuit further includes a second charging circuit having a current value lower than said first charging circuit,
said first charging circuit is disconnected from said signal line before said voltage of said signal line reaches said input voltage, and
said second charging circuit is connected to said signal line after said first charging circuit is disconnected from said signal line, to thereby set said voltage of said signal line at said input voltage.

7. The display apparatus according to claim 1, wherein
said driving circuit further includes a second discharging circuit having a current value lower than said first discharging circuit,
said first discharging circuit is disconnected from said signal line before said voltage of said signal line reaches said input voltage, and
said second discharging circuit is connected to said signal line after said first discharging circuit is disconnected from said signal line, to thereby set said voltage of said signal line at said input voltage.

8. The display apparatus according to claim 1, wherein
said driving circuit further includes:
an input terminal for receiving said input voltage; and
a switching device connected between said input terminal and said signal line, and
said switching device is driven to connect said input terminal and said signal line after one of said first charging circuit and said first discharging circuit is disconnected from said signal line, to thereby set said voltage of said signal line at said input voltage.

9. A display apparatus comprising:
a pixel having a voltage-driven display device;
a signal line serving as a data line connected to said pixel; and
a driving circuit for receiving gradation voltages corresponding to display data, each being received as an input voltage, and writing an output voltage based on said input voltage into said signal line, wherein
said driving circuit includes:
a first charging circuit and a first discharging circuit, each being selectively connected to said signal line;
a precharge circuit for setting a voltage of said signal line at an intermediate voltage between a voltage corresponding to a highlight value and a voltage corresponding to a shadow value; and
a comparator for comparing said input voltage with said voltage of said signal line set at said intermediate voltage, and
one of said first charging circuit and said first discharging circuit is connected to said signal line based on a result of comparison made by said comparator, to thereby set said voltage of said signal line at said input voltage.

10. The display apparatus according to claim 9, wherein
said driving circuit further includes:
switching circuits, one being connected between said signal line and said first charging circuit and the other being connected to said signal line and said first discharging circuit; and
switching control circuits for controlling said switching circuits, respectively, based on a result of comparison made by said comparator.

11. The display apparatus according to claim 9, further comprising
a circuit for reducing power consumption in said comparator after said voltage of said signal line is set equal to said input voltage.

12. The display apparatus according to claim 9, wherein
said driving circuit further includes a second discharging circuit selectively connected to said signal line, and
said second discharging circuit is connected to said signal line after said first charging circuit is disconnected from said signal line, to thereby set said voltage of said signal line having been charged excessively by said first charging circuit, at said input voltage.

13. The display apparatus according to claim 9, wherein
said driving circuit further includes a second charging circuit selectively connected to said signal line, and
said second charging circuit is connected to said signal line after said first discharging circuit is disconnected from said signal line, to thereby set said voltage of said signal line having been discharged excessively by said first discharging circuit, at said input voltage.

14. The display apparatus according to claim 9, wherein
said driving circuit further includes a second charging circuit having a current value lower than said first charging circuit,
said first charging circuit is disconnected from said signal line before said voltage of said signal line reaches said input voltage, and
said second charging circuit is connected to said signal line after said first charging circuit is disconnected from said signal line, to thereby set said voltage of said signal line at said input voltage.

15. The display apparatus according to claim 9, wherein
said driving circuit further includes a second discharging circuit having a current value lower than said first discharging circuit,
said first discharging circuit is disconnected from said signal line before said voltage of said signal line reaches said input voltage, and
said second discharging circuit is connected to said signal line after said first discharging circuit is disconnected from said signal line, to thereby set said voltage of said signal line at said input voltage.

16. The display apparatus according to claim 9, wherein
said driving circuit further includes:
an input terminal for receiving said input voltage; and
a switching device connected between said input terminal and said signal line, and
said switching device is driven to connect said input terminal and said signal line after one of said first charging circuit and said first discharging circuit is disconnected from said signal line, to thereby set said voltage of said signal line, at said input voltage.

17. A display apparatus comprising:
a pixel having a voltage-driven display device;
a data line connected to said pixel;
a gradation voltage generating circuit for generating gradation voltages;
driving circuits, each receiving one of said gradation voltages as an input voltage and outputting an output voltage based on said input voltage;
a signal line for connecting said data line and said driving circuit; and
a decoder circuit for selecting said output voltage corresponding to display data and writing said selected output voltage into said data line, wherein
said driving circuit includes:
a first charging circuit and a first discharging circuit, each being selectively connected to said signal line; and
a comparator for comparing said input voltage input in a current write cycle with a voltage of said signal line set in a preceding write cycle, and
one of said first charging circuit and said first discharging circuit is connected to said signal line based on a result of comparison made by said comparator, to thereby set said voltage of said signal line at said input voltage.

18. A display apparatus comprising:
a pixel having a voltage-driven display device;
a data line connected to said pixel;
a gradation voltage generating circuit for generating gradation voltages;
driving circuits, each receiving one of said gradation voltages as an input voltage and outputting an output voltage based on said input voltage;
a signal line for connecting said data line and said driving circuit; and
a decoder circuit for selecting said output voltage corresponding to display data and writing said selected output voltage into said data line, wherein
said driving circuit includes:
a first charging circuit and a first discharging circuit, each being selectively connected to said signal line;
a precharge circuit for setting a voltage of said signal line at an intermediate voltage between a voltage corresponding to a highlight value and a voltage corresponding to a shadow value; and
a comparator for comparing said input voltage with said voltage of said signal line set at said intermediate voltage, and
one of said first charging circuit and said first discharging circuit is connected to said signal line based on a result of comparison made by said comparator, to thereby set said voltage of said signal line at said input voltage.
